(19) United States
(12) Patent Application Publication
(10) Pub. No.: US 2009/0183669 A1
(43) Pub. Date: Jul. 23, 2009

(54) Temperature-indicating label arrangement and method

(76) Inventors: Christopher J. Scott, West Dundee, IL (US); Christopher Y. Straka, Aurora, IL (US)

Correspondence Address: Christopher J. Scott, P.O. Box 694, West Dundee, IL, 60118, US

(21) Appl. No.: 12/321,556

(22) Filed: Jan. 22, 2009

Related U.S. Application Data
(60) Provisional application No. 61/011,824, filed on Jan. 22, 2008.

(51) Int. Cl. G01K 1/02

(52) U.S. Cl. 116/216; 374/162

(57) ABSTRACT

A label arrangement is outfitted upon a beverage container. The label arrangement comprises a plurality of dynamic zones, each of which is provided with a select thermochromic ink or paint. Each select thermochromic ink or paint is chosen and arranged within the dynamic zones such that a temperature change through a range will effect a series of successive and sequential color or visual changes in the ink or paint media. In other words, as the beverage container changes temperature, the label arrangement will progress through a series of successive and/or sequential color changes as set apart by zones within the label arrangement to effect a visually dynamic temperature indicator.

### PRIOR HISTORY

This application claims the benefit of U.S. Provisional Patent Application No. 61/011,824, filed in the United States Patent and Trademark Office on Jan. 22, 2008.

### BACKGROUND OF THE INVENTION

1. Field of the Invention

The present invention generally relates to a label for visually indicating the approximate temperature of a beverage as contained within a container to which the label is affixed. More particularly the present invention relates to a dynamic visual temperature indicator for placement upon a beverage container for indicating the approximate temperature of the contained beverage, which indicator is designed so as to simulate movement of color within or upon the indicator as the ambient temperature changes.

2. Description of Prior Art

Color change has often been associated with temperature change. The Coors Brewing Company, a division of Molson Coors Brewing Company headquartered in Montreal, QC, Canada and Denver, Colo., USA, has made successful use of this relationship in its well known beer sold under the brand COORS LIGHT as sold in beer bottles. The bottles feature a cold temperature sensitive label using CHROMAZONE™ ink. When the snow covered mountains on the label turn blue, the beer is at optimal drinking temperature. The entire snow-covered mountain scene changes intermediate a blue color (optimal drinking temperature) and a white color (non-optimal drinking temperature) depending on the temperature of the bottle to which the label is attached.

It is further noted, however, that temperature changes are also commonly associated with movements of material and/or movements of color. For example, a length of material will often undergo a significant expansion or elongation when subjected to an increase in temperature. Further, frozen solid material, when heated to its melting point, will liquefy thereby changing phase and often times color. Finally, if a material object is heated, it may undergo color changes, which color changes may migrate from the point closest the heat source toward a point farthest from the heat source as additional heat is applied to the material object.

The foregoing examples suggest various means for indicating temperature change, which if incorporated into a two-dimensional design, could be placed upon the exterior of a beverage container (e.g. in the form of a label) for visually and dynamically indicating the approximate temperature of the container contents. In other words, a first temperature change of the container may well result in a first color movement upon the labeling; and a second temperature change of the container may well result in a second color movement upon the labeling; and so forth. The prior art appears to be silent on such a labeling mechanism, and thus perceives a need therefor.

### SUMMARY OF THE INVENTION

A label comprising a two-dimensional design may be attached or otherwise outfitted upon a container containing a consumable liquid matter. As the beverage container is cooled or chilled, a dynamic visual temperature indicator (as may be exemplified by a snow-capped mountain peak or a thermometer or similar other object capable of indicating a progressive temperature change) will progress through a first series of color changes as set apart by zones within the dynamic visual temperature indicator to effect a temperature change in the container and its contained beverage.

As the beverage/liquid is consumed, or warms, the dynamic visual temperature indicator may thus progress through a second series of color changes in reverse order as compared to the first series of color changes to indicate a warming process of the container and its contents. Conceivably, these color changes within specified zones could be effected for any series of colors and be applied to any consumable beverage as contained within a container (as may be constructed from plastic, glass, or aluminum, for example) outfitted with the dynamic visual temperature indicator.

For example, it is contemplated that if the snow-capped mountain peak were white when cold or at optimal drinking temperature, and that same mountain peak were to become the color of a mountain peak with snow removed when warm, the change in coloration could be harnessed to depict snow melt from the mountain as the bottle grows warmer, thereby effecting a dynamic visual indicator for indicating temperature of the bottle or container and the contained beverage temperature.

It is contemplated that this concept could well be applied to any number of beverage containers, on any product that is contained in a container to which a label or temperature/color-dependent medium could be applied. The resulting effect thus allows a consumer to track beverage/container temperature during the consumption process over a range of temperatures as opposed to the cold-or-warm effect of a blue versus white color scheme.

Other objects of the present invention, as well as particular features, elements, and advantages thereof, will be elucidated or become apparent from, the following description and the accompanying drawing figures.

### BRIEF DESCRIPTION OF THE DRAWINGS

Other features of our invention will become more evident from a consideration of the following brief description of patent drawings:

FIG. 1 is a sequential first plan view of label stock provided with a first dynamic visual temperature indicator (namely, a generic snow-capped mountain peak) depicting five dynamic zones each of which is provided with a select type of thermally sensitive or thermochromic ink and which label stock is at a first temperature (e.g. 0° Celsius) such that all five inks of all five dynamic zones are white in coloration adjacent a statically brown mountain base.

FIG. 2 is a sequential second plan view of the label stock otherwise depicted in FIG. 1, which label stock is at a second temperature greater in magnitude relative to the first temperature (e.g. 5° Celsius) such that the top four inks of the top four dynamic zones are white in coloration adjacent a first bottom dynamic zone appearing brown and the static brown mountain base, thereby effecting a first snow melt from the bottom dynamic zone.

FIG. 3 is a sequential third plan view of the label stock otherwise depicted in FIG. 1, which label stock is at a third temperature greater in magnitude relative to the first temperature (e.g. 10° Celsius) such that the top three inks of the top three dynamic zones are white in coloration adjacent first and second bottom dynamic zones appearing brown and the static brown mountain base, thereby effecting first and second snow melts from the bottom two dynamic zones.

FIG. 4 is a sequential fourth plan view of the label stock otherwise depicted in FIG. 1, which label stock is at a fourth temperature greater in magnitude relative to the first temperature (e.g. 15° Celsius) such that the top two inks of the top two dynamic zones are white in coloration adjacent first through third bottom dynamic zones appearing brown and the static brown mountain base, thereby effecting first through third snow melts from the bottom three dynamic zones.

FIG. 5 is a sequential fifth plan view of the label stock otherwise depicted in FIG. 1, which label stock is at a fifth temperature greater in magnitude relative to the first temperature (e.g. 20° Celsius) such that the ink of the top most dynamic zone is white in coloration adjacent first through fourth bottom dynamic zones appearing brown and the static brown mountain base, thereby effecting snow melts from the bottom four dynamic zones.

FIG. 6 is a sequential sixth plan view of the label stock otherwise depicted in FIG. 1, which label stock is at a sixth temperature greater in magnitude relative to the first temperature (e.g. 25° Celsius) such that the inks of all dynamic zones reveal brown zones adjacent the static brown mountain base, thereby effecting a complete snow melt from the mountain depiction.

FIG. 7 is a sequential first plan view of label stock provided with a second dynamic visual temperature indicator (namely, a mercury-type thermometer) depicting five dynamic zones each of which is provided with a select type of thermally sensitive or thermochromic ink and which label stock is at a first temperature (e.g. 25° Celsius) such that all five inks of all five dynamic zones reveal red coloration adjacent a static white thermometer top.

FIG. 8 is a sequential second plan view of the label stock otherwise depicted in FIG. 7, which label stock is at a second temperature lesser in magnitude relative to the first temperature (e.g. 20° Celsius) such that the top most ink of the top most dynamic zone conceals the red coloration with white coloration adjacent the static white thermometer top, thereby effecting a first drop in temperature.

FIG. 9 is a sequential third plan view of the label stock otherwise depicted in FIG. 7, which label stock is at a third temperature lesser in magnitude relative to the first temperature (e.g. 15° Celsius) such that the top two inks of the top two dynamic zones conceal the red coloration with white coloration adjacent the static white thermometer top, thereby effecting a second drop in temperature.

FIG. 10 is a sequential fourth plan view of the label stock otherwise depicted in FIG. 7, which label stock is at a fourth temperature lesser in magnitude relative to the first temperature (e.g. 10° Celsius) such that the top three inks of the top three dynamic zones conceal the red coloration with white coloration adjacent the static white thermometer top, thereby effecting a third drop in temperature.

FIG. 11 is a sequential fifth plan view of the label stock otherwise depicted in FIG. 7, which label stock is at a fifth temperature lesser in magnitude relative to the first temperature (e.g. 5° Celsius) such that the top four inks of the top four dynamic zones conceal the red coloration with white coloration adjacent the static white thermometer top, thereby effecting a fourth drop in temperature.

FIG. 12 is a sequential sixth plan view of the label stock otherwise depicted in FIG. 7, which label stock is at a sixth temperature lesser in magnitude relative to the first temperature (e.g. 0° Celsius) such that the inks of all dynamic conceal the red coloration with white coloration adjacent the static white thermometer top, thereby effecting a fifth drop in temperature.

FIG. 13 is a sequential first plan view of a temperature indicator arrangement in the form of a circular star or sun depicting four dynamic zones each of which is provided with a select type of thermally sensitive or thermochromic ink and which temperature indicator arrangement is at a first temperature (e.g. 20° Celsius) such that all four inks of all four dynamic zones appear orange in coloration.

FIG. 14 is a sequential second plan view of the temperature indicator arrangement otherwise depicted in FIG. 13, which temperature indicator arrangement is at a second temperature greater in magnitude relative to the first temperature (e.g. 30° Celsius) such that the outer most dynamic zone appears yellow in coloration adjacent the inner three dynamic zones appearing orange in coloration, thereby effecting a hotter star or sun relative to the FIG. 13 star or sun.

FIG. 15 is a sequential third plan view of the temperature indicator arrangement otherwise depicted in FIG. 13, which temperature indicator arrangement is at a third temperature greater in magnitude relative to the first temperature (e.g. 40° Celsius) such that the outer two dynamic zones appear yellow in coloration adjacent the inner two dynamic zones appearing orange in coloration, thereby effecting a star or sun of intermediate heat hotter than the FIG. 14 star or sun.

FIG. 16 is a sequential fourth plan view of the temperature indicator arrangement otherwise depicted in FIG. 13, which temperature indicator arrangement is at a fourth temperature greater in magnitude relative to the first temperature (e.g. 50° Celsius) such that the outer three dynamic zones appear yellow in coloration adjacent the inner most dynamic zone appearing orange in coloration, thereby effecting a hotter star or sun relative to the FIG. 15 star or sun.

FIG. 17 is a sequential fifth plan view of the temperature indicator arrangement otherwise depicted in FIG. 13, which temperature indicator arrangement is at a fifth temperature greater in magnitude relative to the first temperature (e.g. 60° Celsius) such that all four dynamic zones appear yellow in coloration, thereby effecting a fully yellow star or sun of most heat.

FIG. 18 is a sequential first fragmentary side view depiction of a temperature indicator arrangement as printed upon a colored medium, which temperature indicator arrangement comprises five dynamic zones, each of which is printed with a select thermochromic ink or paint and all of which are opaque for masking the colored medium.

FIG. 19 is a sequential second fragmentary side view depiction of the temperature indicator arrangement otherwise shown in FIG. 18, which temperature indicator arrangement shows the left two dynamic zones being translucent and the right three dynamic zones being opaque, thereby revealing the colored medium through the left two dynamic zones.

FIG. 20 is a sequential third fragmentary side view depiction of the temperature indicator arrangement otherwise shown in FIG. 18, which temperature indicator arrangement shows the left four dynamic zones being translucent and the right most dynamic zone being opaque, thereby revealing the colored medium through the left four dynamic zones.

FIG. 21 is a first fragmentary side view depiction of a temperature indicator arrangement as provided upon a first underlying medium, which temperature indicator arrangement comprises a series of dynamic zones, each of which is provided with a select, dynamic thermochromic ink or paint of a first color (depicted with slash marks) as combined with a static ink or paint (depicted with dots), and all of which dynamic inks are opaque for providing a first mixed color scheme upon the first underlying medium.

FIG. 22 is a second enlarged fragmentary side view depiction of the temperature indicator arrangement as provided upon a second underlying medium, which temperature indicator arrangement shows the left five dynamic inks of the left five dynamic zones being translucent and the right four dynamic inks of the left four dynamic zones being opaque, thereby providing the first color scheme at the right four dynamic zones and a second color scheme at the left five dynamic zones.

FIG. 23 is a plan view of a generic rectangular temperature-indicating label arrangement showing a plurality of contiguous, dynamic zones each of which is provided with a select thermochromic medium, and which thermochromic media overlap adjacent dynamic zones.

FIG. 24 is a frontal perspective depiction of a bottle container outfitted with a temperature-indicating label arrangement according to the present invention.

### DETAILED DESCRIPTION OF THE PREFERRED EMBODIMENT

Referring now the drawings with more specificity, it is contemplated that certain thermochromic materials, such as thermochromic paints and thermochromic dyes, as specifically arranged upon an underlying container 21 or label, could be utilized to achieve the dynamic visual effects heretofore described. Thermochromic dyes, for example, are typically based on mixtures of leuco dyes with suitable other chemicals, and may function to display a color change dependent upon temperature.

The dyes typically transition between a translucent (colorless) form and an opaque (colorful) form. The dyes are usually mixed with various materials and encapsulated in microcapsules. The microcapsules are then applied to the target medium such as label stock 20, which may then be affixed to an underlying medium, or, in the alternative, directly to the underlying medium such as a container 21.

It is generally noted that leuco dyes typically exhibit a less accurate temperature response than liquid crystals, and are used in applications where accuracy is not required. They are typically suitable for general indicators of approximate temperature, or for various low cost novelty items. They are usually used in combination with some other pigment, producing a color change between the color of the base pigment and the color of the pigment combined with the color of the non-leuco form of the leuco dye.

Organic leuco dyes are typically available for temperature ranges between about −5° C. and 60° C., in wide range of colors. The color change usually happens in a 3° Celsius interval. Preferably, the temperature-indicating arrangement(s) according to the present invention as specified in more detail hereinafter, are outfitted with reversible thermochromic inks and the like so that temperature increase may result in a translucent state and a temperature decrease may result in an opaque state in a reversible manner. Bearing the foregoing principles in mind, the present invention was conceived.

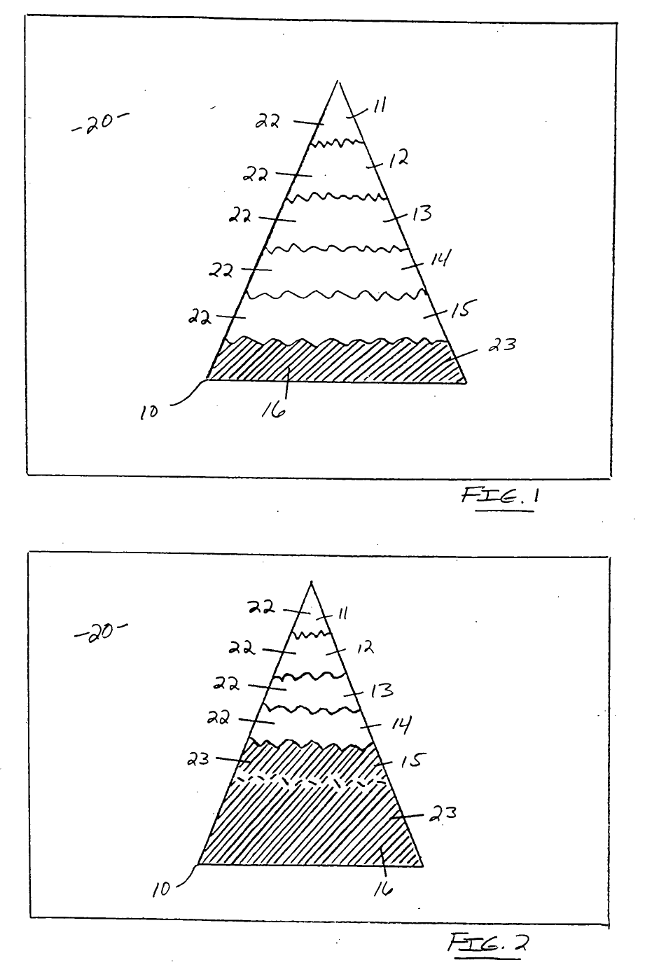

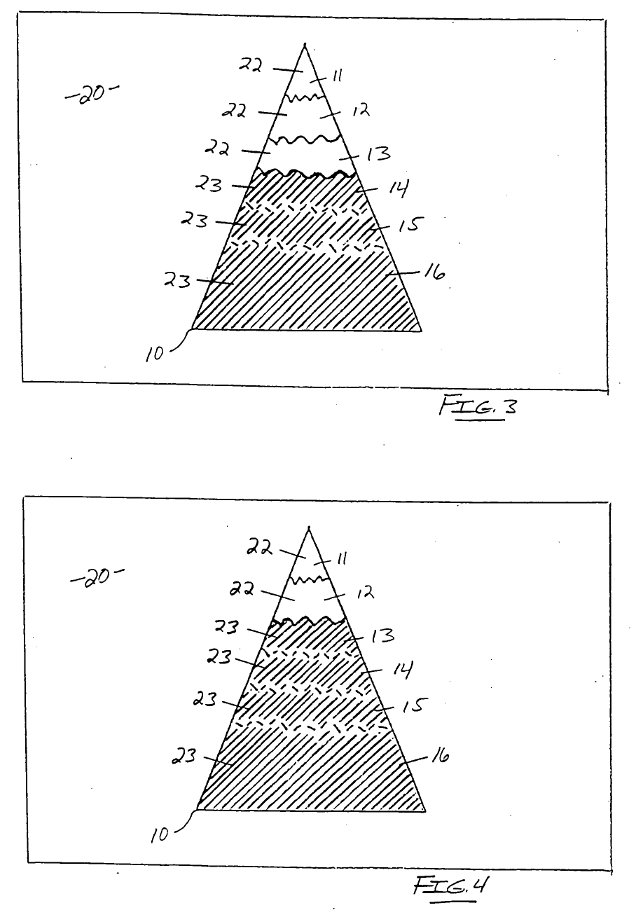

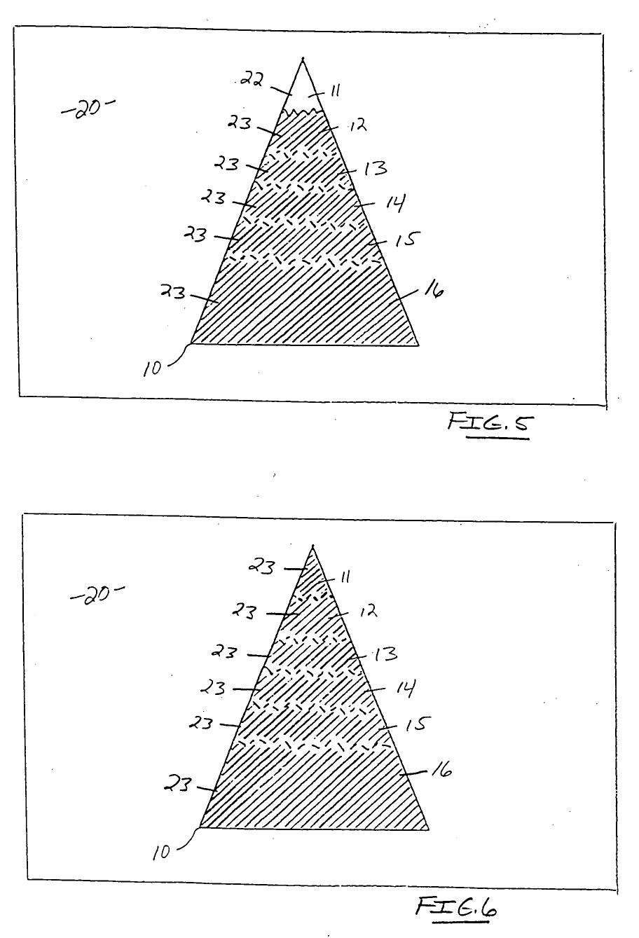

The snow-capped mountain version of the dynamic visual temperature indicator or temperature indicating arrangement 10 as generally depicted in FIGS. 1-6 could conceivably comprise a number of different melt zones (dynamically colored) as at 11, 12, 13, 14, and 15 ranging from zone 11 nearest the pinnacle of the mountain peak depiction to zone 15 nearest the bottom of a mountain as generally depicted in the noted figures. A statically colored mountain base may be further provided as at zone 16.

Notably, each of the zones 11-15 have been provided with white coloration as at 22 in FIG. 1, while zone 16 has been provided with brown coloration as at 23. As the temperature of the container outfitted with label 20 progresses through a temperature range of 0° Celsius to 25° Celsius, a corresponding temperature scale is devised to measure 5 degree increments in temperature as a container warms from 0 degrees Celsius (ice temperature) to 25 degrees Celsius (room temperature).

Each five degree increment may then be correlated with the change in an otherwise opaque zone to a translucent zone, roughly depicting a snow melt from the mountain as generally and comparatively depicted in FIGS. 1-6. In other words, each 5 degree Celsius change would result in successive snow melts from the mountain scene until the container became room temperature and all the opaque white portions (as at 22) of the mountain scene became clear, thereby unmasking the underlying colored medium (in this case brown 23) and depicting a mountain peak devoid of snow thereby indicating a warm beverage container.

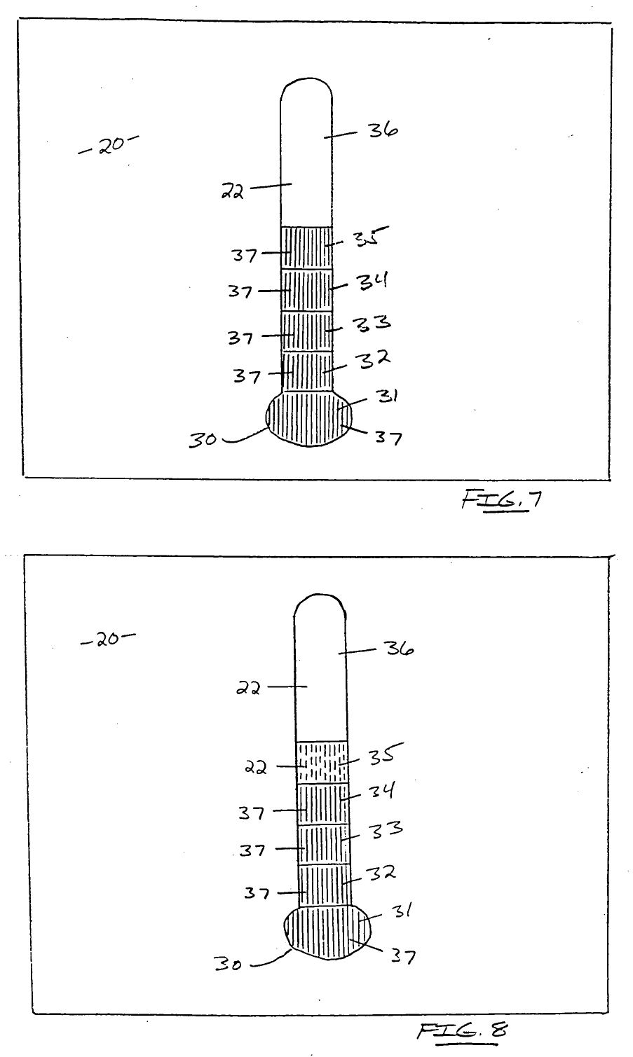

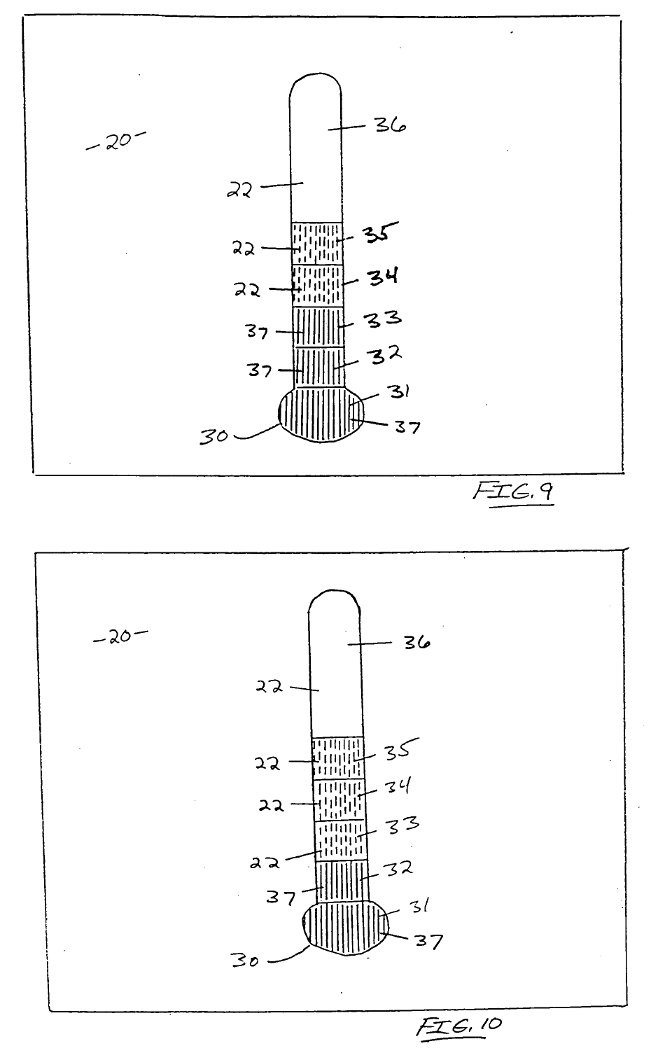

The mercury-type thermometer version of the dynamic visual temperature indicator or temperature indicating arrangement 30 as generally depicted in FIGS. 7-12 could conceivably comprise a number of different liquid level zones (dynamically colored) as at 31, 32, 33, 34, and 35 ranging from zone 31 nearest the base of the thermometer depiction to zone 35 intermediate the height of the thermometer and adjacent statically colored zone 36, as generally depicted in the noted figures.

Notably, each of the dynamically colored zones 31-35 have been provided with red coloration as at 37 in FIG. 7, while zone 36 has been provided with statically white coloration as at 22. As the temperature of the container outfitted with label 20 progresses through a temperature range of 25 degrees Celsius to 0 degrees Celsius, a corresponding temperature scale may be devised to measure 5 degree increments in temperature as a container cools from 25 degrees Celsius (room temperature) to 0 degrees Celsius (ice temperature).

Each five degree increment may then be correlated with the change in an otherwise translucent zone to an opaque zone, roughly depicting a decrease in liquid level in the thermometer as generally and comparatively depicted in FIGS. 7-12. Notably, in FIGS. 8-12, the white coloration 22 is successively masking the red coloration 37 thereby effecting a liquid level drop via color change(s). This masking features may be noted in the via hatch markings depicting red coloration 37 in solid lines being masked by white coloration 22, which masked red coloration appears in broken lines behind white coloration 22.

In other words, each 5 degree Celsius change results in the visual effect of successive liquid level drops within the mercury-type thermometer until the container becomes ice temperature and all the translucent portions of the thermometer became opaque and white 22, depicting a thermometer at minimized temperature and thereby indicating a cold beverage container at optimal drinking temperature.

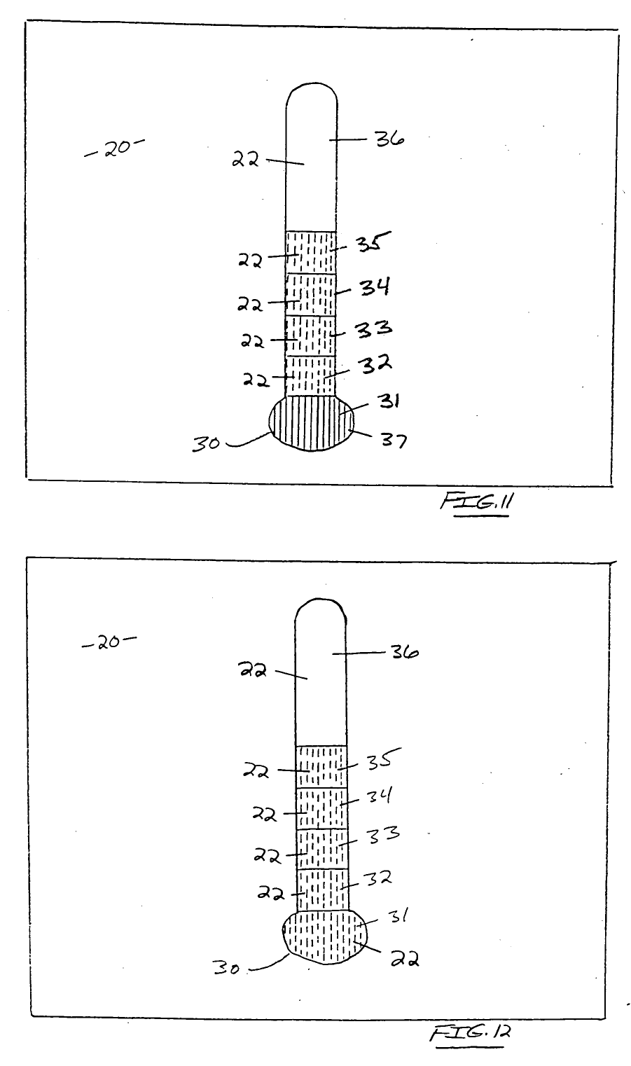

The circular star version of the dynamic visual temperature indicator or temperature indicating arrangement 70 as generally depicted in FIGS. 13-17 could conceivably comprise a number of concentric heat zones (dynamically colored) as at 71, 72, 73, and 74, ranging from zone 71 at the center of the circular star depiction to zone 74 at the outermost radius of the circular star depiction. As may be seen from a comparative inspection of FIGS. 13 and 18, FIG. 13 depicts a fully orange star and FIG. 18 depicts a fully yellow star. FIGS. 14-17 depict a star in various stages intermediate fully orange to fully yellow.

In this last regard, it is contemplated that the dynamically colored thermochromic ink (for example, red colored thermochromic ink or pigment) can be may be used in combination with some other pigment (for example, statically colored yellow ink or pigment) to produce an orange color when fully cool and a yellow color when translucent. In other words, when used in combination with some base pigment of a first color, the thermochromic color alters the color of the base color when opaque and reveals the base color when translucent, thereby producing a color change between the color of the base pigment and the color of the pigment combined with the color of the non-leuco form of the leuco dye.

If the star in FIG. 13 is at 20° Celsius, and all red colored thermochromic inks of each dynamic zone 71-74 are opaque at that temperature but mixed with a yellow base color or pigment, the resulting star will appear yellow. If the star in FIG. 14 is at 30° Celsius and the red colored thermochromic ink of dynamic zone 74 is translucent at that temperature, the base color, namely yellow, is revealed, thereby visually effecting a temperature increase.

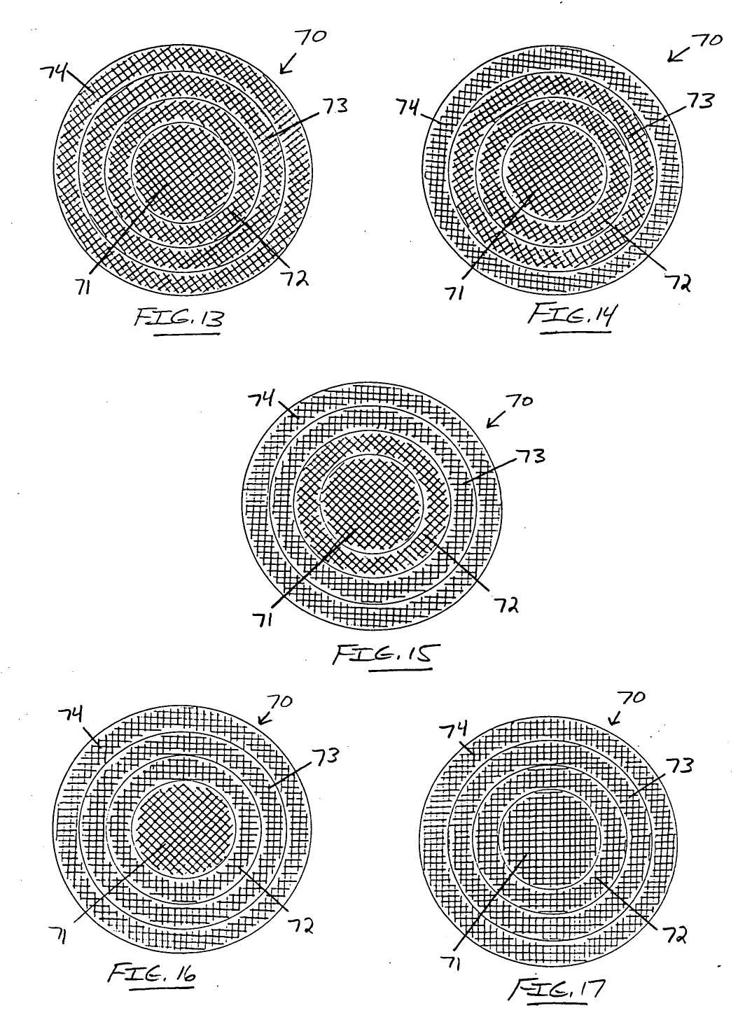

As the temperature warms from 30° Celsius (FIG. 14) to 40° Celsius (FIG. 15) to 50° Celsius (FIG. 16) to 60° Celsius (FIG. 17), successive rings (each being outfitted with a different temperature sensitive ink active at the respective temperatures) change color, thereby visually effecting a radially directed (dynamically moving) color change from the outer circle to the circle center. In this case, yellow moves radially inward from the outer zone 74 to the inner zone 71 as the temperature-indicating arrangement 70 progresses through the temperature change(s).

FIG. 18 is a first sequential fragmentary side view depiction of a dynamic visual temperature indicator or temperature-indicating arrangement as layered or printed upon a colored medium 50 at a first temperature, which dynamic visual temperature indicator comprises five dynamically colored zones 61, 62, 63, 64, and 65. Each of these zones is printed or otherwise outfitted with a temperature specific thermochromic ink that becomes translucent at a given temperature and arranged within the zones so that a temperature increase or decrease will result in adjacent zones becoming progressively translucent or opaque depending on whether the temperature of the dynamic visual temperature indicator increases or decreases.

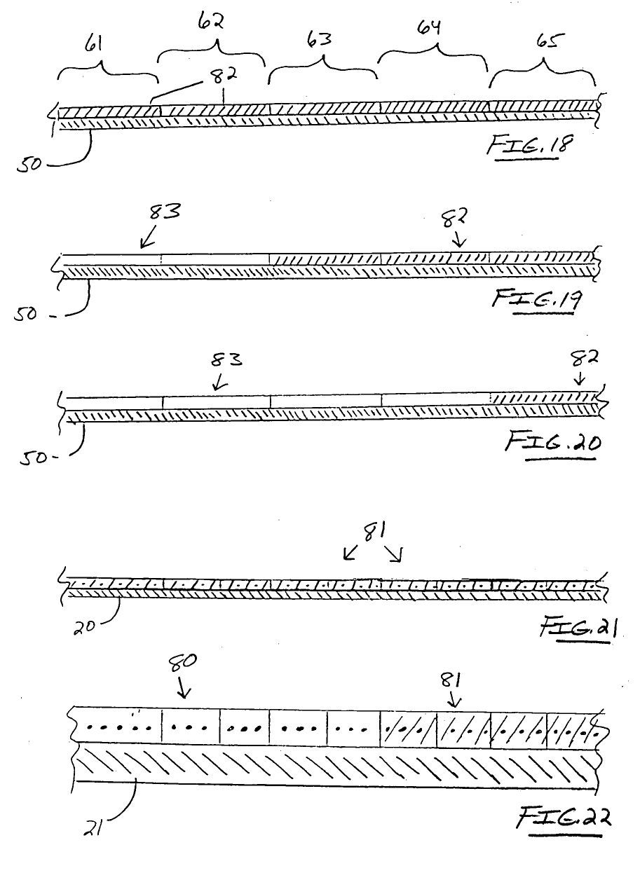

FIG. 19 is a second sequential fragmentary side view depiction of the dynamic visual temperature indicator otherwise shown in FIG. 18 whereby the left two dynamic zones 61 and 62 have become translucent via a temperature increase insufficient to make dynamic zone 63 (and dynamic zones 64-65) turn translucent. FIG. 20 is a third sequential fragmentary side view depiction of a dynamic visual temperature indicator otherwise depicted in FIGS. 18 and 19 whereby the four left two dynamic zones 61-64 have become translucent via a temperature increase insufficient to make dynamic zone 65 turn translucent. The underlying colored medium 50 thus becomes more exposed via zone-based temperature changes and effecting a dynamic visual temperature indicator.

It is contemplated that this structure may be used to support either the mountain scene depiction or the mercury-type thermometer depictions of FIGS. 1-12, whereby the masking zones are depicted as white 22, and the underlying color medium as at 50 may either be brown 23 or red 37 of the examples used in this specification. Notably, FIGS. 18-20 are diagrammatic in nature, and the slash markings used are NOT indicative of color per se, but of zone dynamics as masking color as at 82 reveals underlying colored medium 50 via the translucency 83 of the dynamic zones 61-65.

FIG. 21 is a fragmentary side view depiction of a dynamic visual temperature indicator or temperature-indicating arrangement as printed upon or otherwise affixed to an underlying medium such as label stock 20. The dynamic visual temperature indicator comprises a series of dynamic zones, each of which is provided with a combination of statically colored base ink or pigment (as depicted with dots) and a dynamically colored thermochromic ink (as depicted with slash marks). All of the dynamic inks as generically depicted in FIG. 21 are opaque for providing a first mixed color scheme upon the first underlying medium 20.

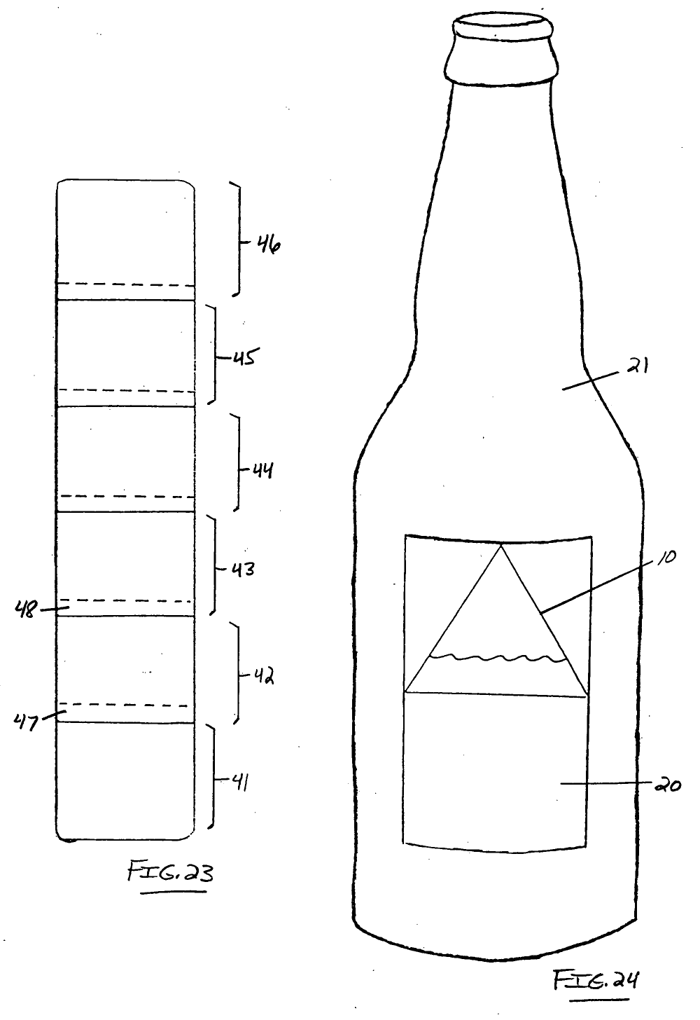

FIG. 22 is a second enlarged fragmentary side view depiction of a temperature indicator arrangement as provided upon a second underlying medium such as medium 21, which temperature indicator arrangement shows the left five dynamic inks of the left five dynamic zones being translucent and the right four dynamic inks of the left four dynamic zones being opaque, thereby providing the first color scheme at the right four dynamic zones (i.e. a combination 81 of two colors) and a second color scheme at the left five dynamic zones (i.e. a single base color 80).

It is contemplated that this structure may be used to support the star depictions of FIGS. 13-17, whereby the fight four zones could be orange in coloration as seen via the yellow base or dot color (80) as combined with a red thermochromic or slash color (81). When the temperature increases and successive red thermochromic inks become translucent, the remaining yellow base or dot color may be seen in the five left most zones.

FIG. 23 depicts a generic rectangular-shaped temperature-indicating label arrangement 40. Label arrangement 40 comprises six overlapping dynamic zones 41, 42, 43, 44, 45, and 46. It is contemplated that the thermochromic media provided to each of zones 41-45 may overlap into adjacent zones. In this regard, the thermochromic medium applied to zone 41 extends into zone 42 at overlap section 47, and the thermochromic medium applied to zone 42 extends into zone 43 at overlap section 48. It is contemplated that the overlapping sections of zones of the dynamic visual temperature indicator may well effect a more visually appealing dynamic visual depiction.

While the foregoing specifications and drawings are set forth in some detail, the specific embodiments described and illustrated thereby are to be considered as exemplifications of the principles of the underlying inventive methodology and are not intended to limit the same to the specific embodiments illustrated. For example, other visual depictions could also be implemented, and the above descriptions of a mountain peak, mercury-type thermometer, and star are merely exemplary. Such other depictions may include a black body, bodies of water, actual temperature readings, or other visual depictions that changes form and/or color during a temperature change.

Further, the dynamic visual temperature indicator arrangement heretofore described may be said to support or teach certain visually perceptible temperature indicating means for effecting a dynamic visual depiction during a temperature change. A container outfitted with such means is thought be novel and unobvious over the state of the art. Further, said temperature indicating means may preferably comprise a plurality of zones, each zone comprising a select thermochromic medium for effecting the dynamic visual depiction. Still further, the thermochromic medium of each zone may preferably change color or from an opaque state to a translucent state in response to a select temperature range, the select temperature ranges being successive and sequential for effecting the dynamic visual depiction.

It should be further understood that the foregoing specifications support certain temperature-indicating methodology for beverage containers. In other words, the present invention provides a method of indicating beverage temperature, which method comprises a series of steps, including: providing a temperature-indicating label arrangement, which label arrangement comprises a plurality of dynamic zones. Further, each dynamic zone is provided with a select thermochromic medium, the thermochromic media being respectively sensitive at varied temperatures.

The label arrangement may then be affixed or otherwise outfitted upon a beverage container, whereafter the beverage container may be exposed to varied ambient temperatures. Heat transfers from more heated environments to less heated environments according to classical thermodynamic principles. According heat is thus transferred relative to the beverage container as it is exposed to varied ambient temperatures, thereby sensitizing select thermochromic media. A plurality of color changes may then be effected within or upon respective dynamic zones via the sensitized thermochromic media. A dynamic visual effect is thus provided via the color-changed dynamic zones of the label arrangement.

The method may further comprise the steps of contiguously arranging the dynamic zones during the step of providing the temperature-indicating label arrangement. In this regard, it may be seen that the dynamic zones of each label arrangement are preferably contiguous or touching in each of the illustrations, though not necessarily so. Conceivably, further designs could be implemented whereby color changes in adjacent, spaced dynamic zones could effect a dynamic visual temperature-indicating depiction. These contiguous zones may be further provided with overlapping thermochromic media, as earlier specified.

The method may further be defined by providing successive and sequential temperature sensitive thermochromic media to the dynamic zones during the step of providing each dynamic zone with a select thermochromic medium. In this regard, it is noted that the dynamic zones need not be sequentially and/or successively arranged with thermochromic media so as to effect a linear movement of change, although in the examples cited, a linear progression of movement whether vertically or radially directed, is preferred.

The method may further comprise the steps of either masking an underlying colored background during the step of providing each dynamic zone with a select thermochromic medium, or combining select thermochromic media with static, base-colored media for effecting a first color scheme before providing the dynamic zones with select thermochromic media. In the first instance, the method may be followed by the step of revealing the underlying colored background when translucently sensitizing select, thermochromic media (i.e. adding heat to the media so as to cause an opaque to translucent change of state) as well as concealing the underlying colored background when opaquely sensitizing select, thermochromic media (i.e. removing heat from the media so as to cause a translucent to opaque change of state).

After combining select thermochromic media with static, base-colored media for effecting a first color scheme before providing the dynamic zones with select thermochromic media, the first color scheme may be changed to a second color scheme as select thermochromic media become translucent during thermochromic media sensitization. Thereafter, the second color scheme may be reverted to the first color scheme as select thermochromic media become opaque during thermochromic media sensitization.

From the specifications then, it will be observed that numerous variations and modifications may be effected without departing from the spirit and scope of the inventive embodiments. It is to be understood that no structural limitation with respect to the specific supporting embodiments illustrated herein is intended or should be inferred. It is, of course, intended to cover by the appended claims all such modifications as fall within the scope of the claims.

We claim:

1. A combination container and temperature-indicating label arrangement, the label arrangement for indicating the temperature of the container, said combination comprising:
a container; and
a temperature-indicating label arrangement, said label arrangement being outfitted upon said container and comprising a plurality of dynamic zones, each dynamic zone being provided with a select, thermochromic medium, the dynamic zones and select, thermochromic media being arranged such that a progressive temperature change effects a visual color change in successive and sequential dynamic zones so as to effect a dynamic visual depiction.

2. The combination of claim 1 wherein the dynamic zones are contiguous.

3. The combination of claim 2 wherein the thermochromic media overlap adjacent dynamic zones, the overlapped thermochromic media for effecting a more visually appealing dynamic visual depiction.

4. The combination of claim 2 wherein the select, thermochromic media mask an underlying colored background, the underlying colored background being successively revealed as successive select, thermochromic media become translucent, the underlying colored background being successively concealed as successive select, thermochromic media become opaque.

5. The combination of claim 2 wherein the select, thermochromic media are combined with static, base-colored media for effecting a first color scheme, the first color scheme changing to a second color scheme as successive select thermochromic media become translucent, the second color scheme reverting to the first color scheme as successive, select thermochromic media become opaque.

6. A label arrangement for use in combination with a container for indicating the temperature of the container, said label arrangement comprising:
a plurality of dynamic zones, each dynamic zone being provided with a select, thermochromic medium, the dynamic zones and select, thermochromic media being arranged such that a progressive temperature change effects a visual color change in the dynamic zones so as to effect a dynamic visual depiction.

7. The label arrangement of claim 6 wherein the progressive temperature change effects a visual color change in successive and sequential dynamic zones so as to effect the dynamic visual depiction.

8. The label arrangement of claim 6 wherein the dynamic zones are contiguous.

9. The combination of claim 8 wherein the thermochromic media overlap adjacent dynamic zones, the overlapped thermochromic media for effecting a more visually appealing dynamic visual depiction.

10. The label arrangement of claim 6 wherein the select, thermochromic media mask an underlying colored background, the underlying colored background being revealed as the select, thermochromic media become translucent, the underlying colored background being concealed as the select thermochromic media become opaque.

11. The label arrangement of claim 6 wherein the select, thermochromic media are combined with a static, base-colored media for effecting a first color scheme, the first color scheme changing to a second color scheme as select thermochromic media become translucent, the second color scheme reverting to the first color scheme as select thermochromic media become opaque.

12. A method of indicating beverage temperature, the method comprising a series of steps, including
providing a temperature-indicating label arrangement, the label arrangement comprising a plurality of dynamic zones;
providing each dynamic zone with a select thermochromic medium, the thermochromic media being respectively sensitive at varied temperatures;
outfitting the label arrangement upon a beverage container;
exposing the beverage container to varied ambient temperatures;
transferring heat relative to the beverage container thereby sensitizing select thermochromic media;
effecting a plurality of color changes within respective dynamic zones via the sensitized thermochromic media; and
providing a dynamic visual effect via the color-changed dynamic zones of the label arrangement.

13. The method of claim 12 comprising the step of contiguously arranging the dynamic zones during the step of providing the temperature-indicating label arrangement.

14. The method of claim 13 comprising the step of overlapping thermochromic media of adjacent dynamic zones during the step of providing each dynamic zone with a select thermochromic medium.

15. The method of claim 12 comprising the step of the providing successive and sequential temperature sensitive thermochromic media to the dynamic zones during the step of providing each dynamic zone with a select thermochromic medium.

16. The method of claim 12 comprising the step of masking an underlying colored background during the step of providing each dynamic zone with a select thermochromic medium.

17. The method of claim 16 comprising the step of revealing the underlying colored background when translucently sensitizing select, thermochromic media.

18. The method of claim 16 comprising the step of concealing the underlying colored background when opaquely sensitizing select, thermochromic media.

19. The method of claim 16 comprising the step of combining select thermochromic media with static, base-colored media for effecting a first color scheme before providing the dynamic zones with select thermochromic media, the first color scheme changing to a second color scheme as select thermochromic media become translucent during thermochromic media sensitization

20. The method of claim 19 wherein the second color scheme reverts to the first color scheme as select thermochromic media become opaque during thermochromic media sensitization.
